(19) United States
(12) Patent Application Publication
(10) Pub. No.: US 2025/0240696 A1
(43) Pub. Date: Jul. 24, 2025

(54) TERMINAL DEVICE, COMMUNICATION METHOD, AND PROGRAM

(71) Applicant: JVCKENWOOD Corporation, Yokohama-shi (JP)

(72) Inventor: Takahiro Mishina, Yokohama-shi (JP)

(21) Appl. No.: 19/074,484

(22) Filed: Mar. 10, 2025

Related U.S. Application Data
(63) Continuation of application No. PCT/JP2023/032394, filed on Sep. 5, 2023.

(30) Foreign Application Priority Data
Sep. 27, 2022 (JP) 2022-153291

(51) Int. Cl. H04W 36/36; H04W 36/12

(52) U.S. Cl. CPC H04W 36/36; H04W 36/12

(57) ABSTRACT

A terminal device includes a communication unit that communicates with a terminal device of a communication counterpart, a communication detection unit that detects a communication state of the server device, a communication determination unit that determines whether or not it is necessary to switch a connection target from a first server device to a second server device different from the first server device, a switching request unit that in a case where it is determined that it is necessary to switch the connection target to the second server device, transmits a switching request signal for requesting a terminal device of a communication counterpart to switch a connection target to the second server device, and a communication switching unit that in a case where a switching preparation completion signal indicating that preparation for switching a connection target to the second server device is completed is received from a terminal device of a communication counterpart, stops transmission of audio information to the first server device and switches the connection target from the first server device to the second server device.

### CROSS-REFERENCE TO RELATED APPLICATIONS

This application is a Continuation of PCT International Application No. PCT/JP2023/032394 filed on Sep. 5, 2023 which claims the benefit of priority from Japanese Patent Application No. 2022-153291 filed on Sep. 27, 2022, the entire contents of both of which are incorporated herein by reference.

### BACKGROUND OF THE INVENTION

### 1. Field of the Invention

The present disclosure relates to a terminal device, a communication method, and a program.

### 2. Description of the Related Art

A push-to-talk over cellular (PoC) system in which a PoC terminal device and a PoC server device are connected to a wireless network such as long term evolution (LTE) and a wired network such as an optical line is known (see, for example, JP 2018-133796 A).

In the PoC system, it is conceivable to continue a voice call by switching the server device to be connected in a case where the communication quality deteriorates or a delay occurs in the voice call depending on the use environment. However, if the server device to be connected is switched during the voice call, it takes time to connect to a new server device and resume the call, and there is a possibility that the voice is interrupted due to loss of a voice packet, retransmission, or the like.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A terminal device that communicates with a terminal device of a communication counterpart via a server device, the terminal device according to the present disclosure comprising: a communication unit that communicates with a terminal device of a communication counterpart; a communication detection unit that detects a communication state of the server device; a communication determination unit that determines whether or not it is necessary to switch a connection target from a first server device to a second server device different from the first server device based on a detection result of the communication detection unit; a switching request unit that in a case where the communication determination unit determines that it is necessary to switch a connection target to the second server device, transmits a switching request signal for requesting a terminal device of a communication counterpart to switch the connection target to the second server device; and a communication switching unit that in a case where a switching preparation completion signal indicating that preparation for switching the connection target to the second server device is completed is received from a terminal device of a communication counterpart, stops transmission of audio information to the first server device and switches the connection target from the first server device to the second server device.

A terminal device that communicates with a terminal device of a communication counterpart via a server device, the terminal device according to the present disclosure comprising: a connection management unit that generates information related to connection with a plurality of server devices; and a communication unit that establishes connection with a plurality of server devices and communicates with a terminal device of a communication counterpart, wherein the connection management unit is configured to, when the same audio information transmitted from a terminal device of a communication counterpart to each of the plurality of server devices is received via the plurality of server devices, in a case where a switching request signal transmitted from a terminal device of a communication counterpart via any one of the plurality of server devices is received, determine whether or not it is possible to switch a server device to be connected, and in a case where it is possible to switch the server device to be connected, perform control such that the audio information is received only from a server device specified based on the switching request signal, and perform control such that a switching preparation completion signal is transmitted to a terminal device of a communication counterpart.

A communication method for communicating with a terminal device of a communication counterpart via a server device, the communicating method according to the present disclosure comprising: a step of communicating with a terminal device of a communication counterpart; a step of detecting a communication state of the server device;
a step of determining whether or not it is necessary to switch a connection target from a first server device to a second server device different from the first server device based on a detection result; a step of, in a case where it is determined that it is necessary to switch the connection target to the second server device, transmitting a switching request signal for requesting a terminal device of a communication counterpart to switch a connection target to the second server device; and a step of, in a case where a switching preparation completion signal indicating that preparation for switching a connection target to the second server device is completed is received from a terminal device of a communication counterpart, stopping transmission of audio information to the first server device and switching the connection target from the first server device to the second server device.

A non-transitory computer-readable storage medium storing a program causing a computer to communicate with a terminal device of a communication counterpart via a server device, the program causing a computer according to the present disclosure to execute: a step of communicating with a terminal device of a communication counterpart; a step of detecting a communication state of the server device; a step of determining whether or not it is necessary to switch a connection target from a first server device to a second server device different from the first server device based on a detection result; a step of, in a case where it is determined that it is necessary to switch the connection target to the second server device, transmitting a switching request signal for requesting a terminal device of a communication counterpart to switch a connection target to the second server device; and a step of, in a case where a switching preparation completion signal indicating that preparation for switching a connection target to the second server device is completed is received from a terminal device of a communication counterpart, stopping transmission of audio information to the first server device and switching the connection target from the first server device to the second server device.

### BRIEF DESCRIPTION OF THE DRAWINGS

FIG. 1 is a diagram illustrating a configuration example of a communication system according to an embodiment;

FIG. 2 is a block diagram illustrating a configuration example of a terminal device according to the embodiment;

FIG. 3 is a block diagram illustrating a configuration example of a server device according to the embodiment;

FIG. 4 is a flowchart illustrating processing content of the terminal device according to the embodiment;

FIG. 5 is a flowchart illustrating processing content of the terminal device on a transmission side according to the embodiment; and

FIG. 6 is a sequence diagram illustrating processing content of the communication system according to the embodiment.

### DETAILED DESCRIPTION OF THE PREFERRED EMBODIMENTS

Hereinafter, embodiments according to the present disclosure will be described in detail with reference to the accompanying drawings. Note that the present disclosure is not limited by this embodiment, and in the following embodiment, the same parts are denoted by the same reference numerals, and redundant description will be omitted.

### Embodiment

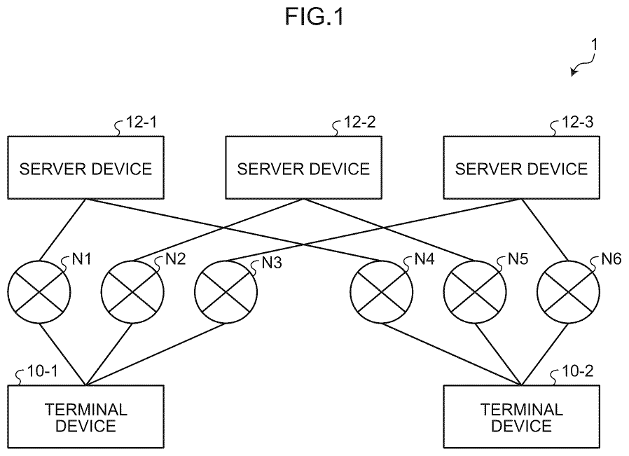

A configuration example of a communication system according to the embodiment will be described with reference to FIG. 1. FIG. 1 is a diagram illustrating a configuration example of the communication system according to the embodiment.

As illustrated in FIG. 1, a communication system 1 includes a server device 12-1, a server device 12-2, a server device 12-3, a terminal device 10-1, and a terminal device 10-2. The server devices 12-1 to 12-3 may be collectively referred to as a server device 12. The terminal device 10-1 and the terminal device 10-2 may be collectively referred to as a terminal device 10. The communication system 1 includes three server devices 12, from the server device 12-1 to the server device 12-3, but the present disclosure is not limited thereto. The communication system 1 includes two terminal devices 10, the terminal device 10-1 and the terminal device 10-2, but the present disclosure is not limited thereto.

The server device 12-1 to the server device 12-3 are PoC servers. The terminal device 10-1 and the terminal device 10-2 are PoC terminals. That is, the communication system 1 is a system supporting PoC.

Each of the server devices 12-1 to 12-3 registers the terminal device 10-1 and the terminal device 10-2 as terminal devices included in the communication system 1. The server device 12-1 to the server device 12-3 store the same registration information such as group setting for the terminal device 10-1 and the terminal device 10-2. Each of the server devices 12-1 to 12-3 does not communicate with other server devices 12 each other. The server devices 12-1 to 12-3 can specify the terminal device 10 performing communication.

The terminal device 10-1 is connected to the server device 12-1 via a network N1. The terminal device 10-1 is connected to the server device 12-2 via a network N2. The terminal device 10-1 is connected to the server device 12-3 via a network N3. That is, the terminal device 10-1 is connected to the server devices 12-1 to 12-3 via different networks. The terminal device 10-1 can maintain a communication session with each of the server devices 12-1 to 12-3.

The terminal device 10-2 is connected to the server device 12-1 via a network N4. The terminal device 10-2 is connected to the server device 12-2 via a network N5. The terminal device 10-3 is connected to the server device 12-3 via a network N6. That is, the terminal device 10-2 is connected to the server devices 12-1 to 12-3 via different networks. The terminal device 10-2 can maintain a communication session with each of the server devices 12-1 to 12-3.

The networks N1 to N6 are networks including a wireless network and a wired network. In a case where it is not necessary to distinguish among the networks N1 to N6, the network may be collectively referred to as a network N. Here, in the network connection between the terminal devices 10-1 or 10-2 and the server device 12, it is desirable that the networks N1 to N6 establish communication sessions as different communication connections and communication paths each other. The different communication connections and communication paths are preferably based on physically different communication paths, logically different communication paths, different communication schemes, different frequencies, and different time slots. The terminal device 10-1 and the terminal device 10-2 may be connected to a plurality of such different networks to enable multi-session connection.

Each of the terminal device 10-1 and the terminal device 10-2 stores information regarding the server device 12 that can be connected to each other.

### Terminal Device

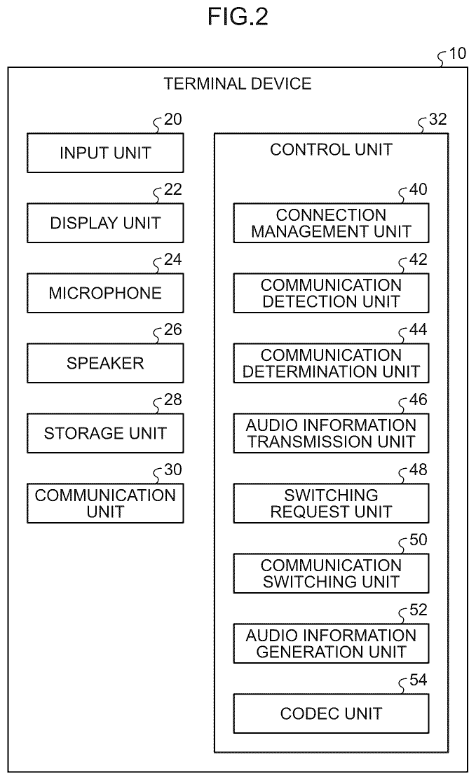

A configuration example of a terminal device according to the embodiment will be described with reference to FIG. 2. FIG. 2 is a block diagram illustrating a configuration example of the terminal device according to the embodiment.

As illustrated in FIG. 2, the terminal device 10 includes an input unit 20, a display unit 22, a microphone 24, a speaker 26, a storage unit 28, a communication unit 30, and a control unit 32.

The input unit 20 receives various input operations to the terminal device 10. The input unit 20 outputs an operation signal corresponding to the received input operation to the control unit 32. The input unit 20 includes, for example, a touch panel, a button, a switch, a push-to-talk (PTT) button, and the like. In a case where a touch panel is used as the input unit 20, the input unit 20 is arranged on the display unit 22.

The display unit 22 displays various videos. The display unit 22 is a display including, for example, a liquid crystal display, organic electro-luminescence (EL), and the like.

The microphone 24 is a microphone that detects a voice around the terminal device 10. The microphone 24 detects the voice of a user who uses the terminal device 10. The microphone 24 converts the detected voice into an audio signal.

The speaker 26 is a speaker that outputs various sounds.

The storage unit 28 stores various types of information. The storage unit 28 stores information such as calculation content of the control unit 32 and a program. The storage unit 28 includes, for example, at least one of a random access memory (RAM), a main storage device such as a read only memory (ROM), and an external storage device such as a hard disk drive (HDD).

The communication unit 30 is a communication interface that executes communication between the terminal device 10 and an external device. The communication unit 30 executes communication between the terminal device 10 and the server device 12.

The control unit 32 controls each unit of the terminal device 10. The control unit 32 includes, for example, an information processing device such as a central processing unit (CPU) or a micro processing unit (MPU), and a storage device such as a RAM or a ROM. The control unit 32 executes a program for controlling the operation of the terminal device 10 according to the present disclosure. The control unit 32 may be realized by, for example, an integrated circuit such as an application specific integrated circuit (ASIC) or a field programmable gate array (FPGA). The control unit 32 may be realized by a combination of hardware and software.

The control unit 32 includes a connection management unit 40, a communication detection unit 42, a communication determination unit 44, an audio information transmission unit 46, a switching request unit 48, a communication switching unit 50, an audio information generation unit 52, and a codec unit 54.

The connection management unit 40 establishes connection with a plurality of server devices 12 included in the communication system 1. Specifically, the connection management unit 40 establishes connection with the plurality of server devices 12 by requesting the plurality of server devices 12 for registration.

The communication detection unit 42 detects a communication state with the server device 12. Specifically, the communication detection unit 42 detects a communication state with the server device 12 that is a current connection target. The communication detection unit 42 can detect the bit rate as the communication state, for example, but is not limited thereto. For example, the communication detection unit 42 detects the length of the delay caused in the communication with the server device 12 that is the current connection target on the basis of the communication state. A known method can be used as a method for detecting the delay caused in communication, and the method is not limited. The server device 12 that is the current connection target is also referred to as a first server device.

The communication determination unit 44 determines whether or not it is necessary to switch the connection target from the server device 12 that is the current connection target to another server device 12 on the basis of the detection result of the communication state by the communication detection unit 42. For example, the communication determination unit 44 determines to switch the connection target to another server device 12 when the delay caused in communication with the server device 12 that is the current connection target is equal to or more than a predetermined value. The server device 12 to be switched is also referred to as a second server device.

The audio information transmission unit 46 generates audio information regarding the voice of the user of the terminal device 10 detected by the microphone 24 in the server device 12 that is the current connection target and the server device 12 to be switched, and transmits the generated audio information via the communication unit 30. That is, the audio information transmission unit 46 transmits the same audio information to the server device 12 that is the current connection target and the server device 12 to be switched. For example, the audio information transmission unit 46 may transmit time information (time stamp) indicating the current time together with the audio information.

In a case where the communication determination unit 44 determines that it is necessary to switch the connection target to another server device 12, the switching request unit 48 transmits a switching request signal to the other server device 12.

The communication switching unit 50 switches the server device 12 that communicates with the terminal device 10. When receiving a switching preparation completion signal from the server device 12 that is the current connection target or the server device 12 to be switched, the communication switching unit 50 switches the server device 12 to be connected from the server device 12 that is the current connection target to the server device 12 to be switched. In this case, the audio information transmission unit 46 stops the transmission of the audio information to the server device 12 that is the current connection target when switching the server device 12 to communication handling.

The audio information generation unit 52 generates audio information. For example, the audio information generation unit 52 generates audio information to be transmitted to the server device 12 that is the current connection target, on a basis of the voice detected by the microphone 24. For example, the audio information generation unit 52 duplicates the audio information to be transmitted to the server device 12 that is the current connection target, and generates the audio information to be transmitted to the server device 12 that is the switching target.

The codec unit 54 compresses, for example, the audio information to be transmitted to the server device 12 by an arbitrary compression method. The codec unit 54 decodes, for example, the audio information received from the server device 12.

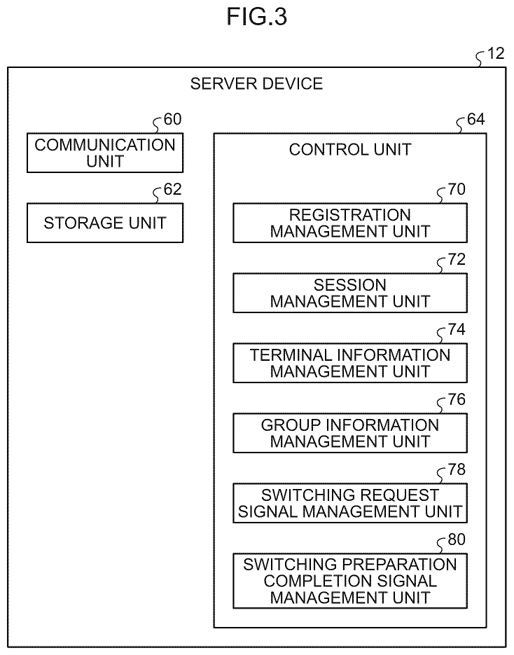

A configuration example of the server device according to the embodiment will be described with reference to FIG. 3. FIG. 3 is a block diagram illustrating a configuration example of the server device according to the embodiment.

As illustrated in FIG. 3, the server device 12 includes a communication unit 60, a storage unit 62, and a control unit 64.

The communication unit 60 is a communication interface that executes communication between the server device 12 and an external device. The communication unit 60 executes communication between the server device 12 and the terminal device 10.

The storage unit 62 stores various types of information. The storage unit 62 stores information such as calculation content of the control unit 64 and a program. The storage unit 62 includes, for example, at least one of a RAM, a main storage device such as a ROM, and an external storage device such as an HDD.

The control unit 64 controls each unit of the server device 12. The control unit 64 includes, for example, an information processing device such as a CPU or an MPU, and a storage device such as a RAM or a ROM. The control unit 64 executes a program for controlling the operation of the server device 12 according to the present disclosure. The control unit 64 may be realized by, for example, an integrated circuit such as an ASIC or an FPGA. The control unit 64 may be realized by a combination of hardware and software.

The control unit 64 includes a registration management unit 70, a session management unit 72, a terminal information management unit 74, a group information management unit 76, a switching request signal management unit 78, and a switching preparation completion signal management unit 80.

The registration management unit 70 receives registration from each terminal device 10. The registration management unit 70 registers the terminal device 10 that has received the registration as the communicable terminal device 10.

The session management unit 72 manages a communication session with the terminal device 10. For example, the session management unit 72 transmits audio information received from the terminal device 10 to another terminal device 10 as audio information.

The terminal information management unit 74 causes the storage unit 62 to store various types of information regarding the terminal device 10 that has received the registration.

The group information management unit 76 manages the group information regarding the group to which the terminal device 10 belongs stored in the storage unit 62.

The switching request signal management unit 78 manages the switching request signal received from the terminal device 10. The switching request signal management unit 78 transmits the switching request signal received from the terminal device 10 to another terminal device 10.

The switching preparation completion signal management unit 80 manages the switching preparation completion signal. The switching preparation completion signal management unit 80 transmits the switching preparation completion signal received from the terminal device 10 on the reception side to the terminal device 10 on the transmission side.

### Processing Content

### Processing Content of Terminal Device on Reception Side

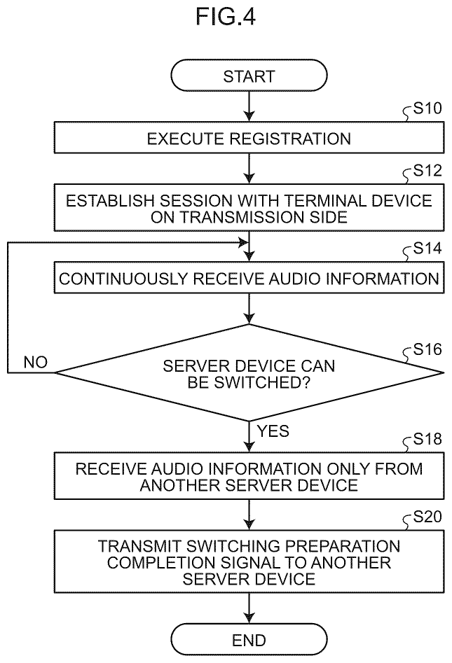

Processing content of the terminal device on the reception side according to the embodiment will be described with reference to FIG. 4. FIG. 4 is a flowchart illustrating the processing content of the terminal device according to the embodiment.

Hereinafter, in the example illustrated in FIG. 1, it is assumed that the terminal device 10-1 is the terminal device 10 on the transmission side, and the terminal device 10-2 is the terminal device 10 on the reception side. In addition, it is assumed that the terminal device 10-1 and the terminal device 10-2 establish sessions with the server device 12-1 and the server device 12-2. It is assumed that the server device 12-1 is the server device 12 that is the current connection target.

The connection management unit 40 of the terminal device 10-2 executes registration on the server device 12-1 and the server device 12-2 (step S10). Then, the process proceeds to step S12.

The connection management unit 40 of the terminal device 10-2 establishes a session with the terminal device 10-1 via the server device 12-1 (step S12). Then, the process proceeds to step S14.

The connection management unit 40 of the terminal device 10-2 continuously receives, from each of the server device 12-1 and the server device 12-2, the audio information transmitted by the terminal device 10-1 (step S14). Then, the process proceeds to step S16.

The connection management unit 40 of the terminal device 10-2 receives a switching request signal and determines whether or not the server device to be connected can be switched on the basis of the switching request signal (step S16). In a case where the switching request signal is received and it is determined that the server device to be connected can be switched (step S16; Yes), the process proceeds to step S18. If it is not determined that the switching request signal is received (step S16; No), the process proceeds to step S14. Here, whether or not it is possible to switch the server device to be connected may be determined by determining whether or not communication is possible on the basis of the communication quality of the network connected to the server device that has received the switching request signal, and if it is determined that communication is possible, it may be determined that it is possible to switch the server device to be connected. It may be determined whether or not communication is possible on the basis of a communication state with the server device 12 detected by the communication detection unit 42. For example, it may be determined that communication is possible if the delay caused in the communication with the server device 12 to be switched is less than a predetermined value. In addition, for example, it may be determined that communication is possible if the bit rate in the communication with the server device 12 to be switched is more than a predetermined value.

If it is determined as Yes in step S16, the connection management unit 40 of the terminal device 10-2 receives audio information only from another server device specified on the basis of the switching request signal (step S18). Here, on the basis of reception of the switching request signal via the server device 12-2, control may be performed such that the audio information is received only from the server device 12-2. In addition, in a case where the connection destination information to the new server device 12 is included in the switching request signal, control may be performed such that the audio information is received only from the new server device 12 on the basis of the connection destination information to the new server device 12. Then, the process proceeds to step S20.

The connection management unit 40 of the terminal device 10-2 transmits a switching preparation completion signal to the server device 12-2 (step S20). Specifically, the connection management unit 40 of the terminal device 10-2 transmits the switching preparation completion signal to the server device 12-2 if the server device 12-2 or the audio information can be normally received. Then, the processing of FIG. 4 is ended.

### Processing Content of Terminal Device on Transmission Side

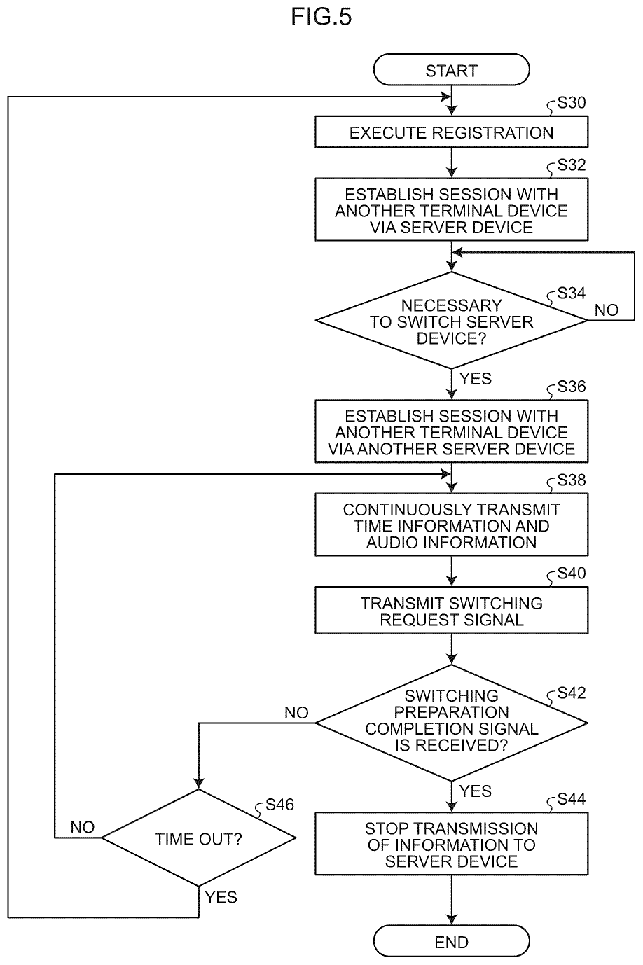

Processing content of the terminal device on the transmission side according to the embodiment will be described with reference to FIG. 5. FIG. 5 is a flowchart illustrating the processing content of the terminal device on the transmission side according to the embodiment.

The connection management unit 40 of the terminal device 10-1 executes registration on the server device 12-1 and the server device 12-2 (step S30). Then, the process proceeds to step S32.

The connection management unit 40 of the terminal device 10-1 establishes a session with the terminal device 10-2 via the server device 12-1 (step S32). Then, the process proceeds to step S34.

The communication determination unit 44 of the terminal device 10-1 determines whether or not it is necessary to switch from the server device 12-1 to the server device 12-2 (step S34). Specifically, the communication determination unit 44 of the terminal device 10-1 determines whether or not it is necessary to switch from the server device 12-1 to the server device 12-2 on the basis of the detection result of the communication state by the communication detection unit 42 of the terminal device 10-1. If it is determined that switching from the server device 12-1 to the server device 12-2 is necessary (step S34; Yes), the process proceeds to step S36. If it is not determined that switching from the server device 12-1 to the server device 12-2 is necessary (step S34; No), the process of step S34 is repeated.

If it is determined as Yes in step S34, the connection management unit 40 of the terminal device 10-1 establishes a session with the terminal device 10-2 via the server device 12-2 (step S36). The process proceeds to step S38.

The audio information transmission unit 46 of the terminal device 10-1 continuously transmits the time information indicating the current time and the audio information related to the voice of the user of the terminal device 10-1 to the server device 12-1 and the server device 12-2 (step S38). Specifically, the audio information transmission unit 46 of the terminal device 10-1 continuously transmits the same time information and the same audio information to the server device 12-1 and the server device 12-2. Then, the process proceeds to step S40.

The switching request unit 48 of the terminal device 10-1 transmits the switching request signal to the server device 12-2. (Step S40). Then, the process proceeds to step S42.

The connection management unit 40 of the terminal device 10-1 determines whether or not a switching preparation completion signal is received (step S42). Specifically, the connection management unit 40 of the terminal device 10-1 determines whether or not a switching preparation completion signal is received from the server device 12-2. If it is determined that the switching preparation completion signal is received (step S42; Yes), the process proceeds to step S44. If it is not determined that the switching preparation completion signal is received (step S42; No), the process proceeds to step S46.

If it is determined as Yes in step S42, the audio information transmission unit 46 of the terminal device 10-1 stops the transmission of the audio to the server device 12-1 (step S44). Then, the processing of FIG. 5 is ended.

If it is determined as No in step S42, the connection management unit 40 of the terminal device 10-1 determines whether a predetermined time has elapsed since the switching request unit 48 transmitted the switching request signal and a timeout has occurred (step S46). If it is determined that the timeout has occurred (step S46; Yes), the process proceeds to step S30. If it is not determined that the timeout has occurred (step S46; No), the process proceeds to step S38.

### Processing Content of Communication System

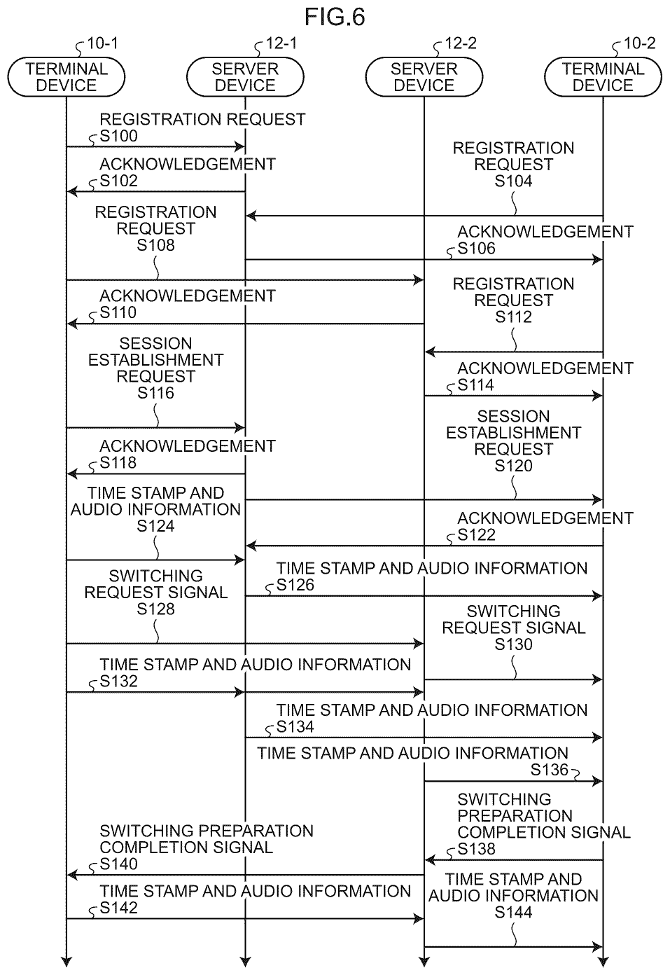

Processing content of a communication system according to the embodiment will be described with reference to FIG. 6. FIG. 6 is a sequence diagram illustrating the processing content of the communication system according to the embodiment.

The terminal device 10-1 transmits a registration request to the server device 12-1 (step S100). The server device 12-1 transmits an acknowledgement indicating that the registration request is permitted to the terminal device 10-1 (the process proceeds to step S102).

The terminal device 10-2 transmits a registration request to the server device 12-1 (step S104). The server device 12-1 transmits an acknowledgement indicating that the registration request is permitted to the terminal device 10-2 (the process proceeds to step S106).

The terminal device 10-1 transmits a registration request to the server device 12-2 (step S108). The server device 12-2 transmits an acknowledgement indicating that the registration request is permitted to the terminal device 10-1 (the process proceeds to step S110).

The terminal device 10-2 transmits a registration request to the server device 12-2 (step S112). The server device 12-2 transmits an acknowledgement indicating that the registration request is permitted to the terminal device 10-2 (the process proceeds to step S114).

Through the processing from step S100 to step S114, the registration of each terminal device 10 to each server device 12 is completed.

The terminal device 10-1 transmits a session establishment request to the server device 12-1 to establish a session in order to communicate with the terminal device 10-2 (step S116). The server device 12-1 transmits an acknowledgement indicating that the session establishment is permitted to the terminal device 10-1 (step S118).

The server device 12-1 transmits the session establishment request received from the terminal device 10-1 to the terminal device 10-2 (step S120). The terminal device 10-2 transmits an acknowledgement indicating that the session establishment is permitted to the server device 12-1 (step S122).

By the processing from step S116 to step S122, a session between the terminal device 10-1 and the terminal device 10-2 is established, and the terminal device 10-1 and the terminal device 10-2 can communicate with each other.

The terminal device 10-1 transmits the time stamp and the audio information to the server device 12-1 (step S124). The server device 12-1 transmits the time stamp and the audio information received from the terminal device 10-1 to the terminal device 10-2 (step S126).

If it is determined that it is necessary to switch the connection target from the server device 12-1 to the server device 12-2, the terminal device 10-1 transmits a switching request signal to the server device 12-2 (step S128). The server device 12-2 transmits the switching request signal received from the terminal device 10-1 to the terminal device 10-2 (step S130).

The terminal device 10-1 transmits the time stamp and the audio information to the server device 12-1 and the server device 12-2 (step S132). In step S132, the terminal device 10-1 transmits the same information to the server device 12-1 and the server device 12-2.

The process proceeds to the step where the server device 12-1 transmits the time stamp and the audio information received from the terminal device 10-1 to the terminal device 10-2 (step S134). The server device 12-2 transmits the time stamp and the audio information received from the terminal device 10-1 to the terminal device 10-2 (step S136). In steps S134 and S136, the terminal device 10-2 receives the same information from the server device 12-1 and the server device 12-2.

In a case where the time stamp and the audio information can be normally received from both of the server device 12-1 and the server device 12-2, the terminal device 10-2 transmits a switching preparation completion signal to the server device 12-2 (step S138). The server device 12-2 transmits the switching preparation completion signal received from the terminal device 10-2 to the terminal device 10-1 (step S140).

By the processing from step S128 to step S140, the server device 12 to be connected is switched from the server device 12-1 to the server device 12-2.

The terminal device 10-1 transmits the time stamp and the audio information to the server device 12-2 (step S142). The server device 12-2 transmits the time stamp and the audio information received from the terminal device 10-1 to the terminal device 10-2 (step S144). Then, the processing of FIG. 6 is ended.

As described above, in the present embodiment, it is possible to switch the connection target to the server device to be switched while maintaining communication with the server device that is the current connection target. As a result, in the present embodiment, since the connection target can be switched to the server device to be switched before a delay occurs in the server device that is the current connection target, the occurrence of the delay can be reduced.

Each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like. Note that this configuration by distribution and integration may be performed dynamically.

According to the present disclosure, it is possible to easily switch the server device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal device that communicates with a terminal device of a communication counterpart via a server device, the terminal device comprising:
a communication unit that communicates with a terminal device of a communication counterpart;
a communication detection unit that detects a communication state of the server device;
a communication determination unit that determines whether or not it is necessary to switch a connection target from a first server device to a second server device different from the first server device based on a detection result of the communication detection unit;
a switching request unit that in a case where the communication determination unit determines that it is necessary to switch a connection target to the second server device, transmits a switching request signal for requesting a terminal device of a communication counterpart to switch the connection target to the second server device; and
a communication switching unit that in a case where a switching preparation completion signal indicating that preparation for switching the connection target to the second server device is completed is received from a terminal device of a communication counterpart, stops transmission of audio information to the first server device and switches the connection target from the first server device to the second server device.

2. The terminal device according to claim 1, wherein
the switching request unit determines that a switching completion condition is satisfied in a case where a predetermined period elapses after the switching request signal is transmitted, or in a case where the switching request signal is transmitted and the switching preparation completion signal is received.

3. A terminal device that communicates with a terminal device of a communication counterpart via a server device, the terminal device comprising:
a connection management unit that generates information related to connection with a plurality of server devices; and
a communication unit that establishes connection with a plurality of server devices and communicates with a terminal device of a communication counterpart, wherein
the connection management unit is configured to,
when the same audio information transmitted from a terminal device of a communication counterpart to each of the plurality of server devices is received via the plurality of server devices, in a case where a switching request signal transmitted from a terminal device of a communication counterpart via any one of the plurality of server devices is received, determine whether or not it is possible to switch a server device to be connected, and in a case where it is possible to switch the server device to be connected, perform control such that the audio information is received only from a server device specified based on the switching request signal, and perform control such that a switching preparation completion signal is transmitted to a terminal device of a communication counterpart.

4. A communication method for communicating with a terminal device of a communication counterpart via a server device, the communicating method comprising:
a step of communicating with a terminal device of a communication counterpart;
a step of detecting a communication state of the server device;
a step of determining whether or not it is necessary to switch a connection target from a first server device to a second server device different from the first server device based on a detection result;
a step of, in a case where it is determined that it is necessary to switch the connection target to the second server device, transmitting a switching request signal for requesting a terminal device of a communication counterpart to switch a connection target to the second server device; and
a step of, in a case where a switching preparation completion signal indicating that preparation for switching a connection target to the second server device is completed is received from a terminal device of a communication counterpart, stopping transmission of audio information to the first server device and switching the connection target from the first server device to the second server device.

5. A non-transitory computer-readable storage medium storing a program causing a computer to communicate with a terminal device of a communication counterpart via a server device, the program causing a computer to execute:
a step of communicating with a terminal device of a communication counterpart;
a step of detecting a communication state of the server device;
a step of determining whether or not it is necessary to switch a connection target from a first server device to a second server device different from the first server device based on a detection result;
a step of, in a case where it is determined that it is necessary to switch the connection target to the second server device, transmitting a switching request signal for requesting a terminal device of a communication counterpart to switch a connection target to the second server device; and
a step of, in a case where a switching preparation completion signal indicating that preparation for switching a connection target to the second server device is completed is received from a terminal device of a communication counterpart, stopping transmission of audio information to the first server device and switching the connection target from the first server device to the second server device.
